(19) United States
(12) Patent Application Publication
(10) Pub. No.: US 2006/0276284 A1
(43) Pub. Date: Dec. 7, 2006

(54) Automotive accessory drive system and method of operation

(76) Inventors: David R. Lancaster, Troy, MI (US); James G. Solomon, Grosse Pointe Woods, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/144,251

(22) Filed: Jun. 3, 2005

(51) Int. Cl. F16H 7/08; F16H 7/12; F16H 7/22

(52) U.S. Cl. 474/110; 474/133; 474/109

(57) ABSTRACT

The present invention provides an automotive accessory drive system and method having a selectively lockable flexible drive belt tensioner with a damper element filled with a variable viscosity fluid with magneto-rheological or electro-rheological properties. When the combined alternator/starter motor of a belt alternator starter (BAS) system is commanded to restart the engine, the locked flexible drive belt tensioner will apply force to the normally slack side of the flexible drive belt, thereby maintaining frictional engagement between the flexible drive belt and the drive and driven pulleys. Upon engine restart, the tensioner will unlock and resume normal operation.

### TECHNICAL FIELD

The present invention provides an automotive accessory drive system with a selectively lockable flexible drive belt tensioner and a method for restarting a Belt Alternator Starter (BAS) system equipped engine.

### BACKGROUND OF THE INVENTION

With the current desire for fuel efficient and low emission vehicles, many novel solutions for internal combustion engine architecture and operating strategies have been developed. One such idea is the Belt Alternator Starter (BAS) system. This system provides increases in fuel economy by shutting off the engine when at an idle operating mode, and enabling early fuel cut-off during decelerations. The BAS system can also accommodate regenerative braking. The BAS system combines engine controls with a combined alternator/starter motor mounted with respect to the engine in a typical accessory drive position. As such, this BAS strategy has minimal impact on engine and transmission architectures when compared to other hybrid strategies.

The typical automotive accessory drive system consists of a drive pulley connected to an output shaft of the engine, typically the crankshaft. Wrapped around this pulley is a flexible drive belt, which in turn is wrapped around a plurality of driven pulleys. This flexible drive belt transmits drive forces between the drive pulley and the driven pulleys. The driven pulleys may be fixably attached to accessories known in the art such as a power steering pump, air conditioning compressor, alternator, and secondary air pump. However, some of these driven pulleys may be idler pulleys which may be used to ensure proper belt wrap of a given driven pulley or they may be used to ensure proper belt routing.

The BAS system employs a combined starter/alternator motor mounted with respect to the other components of the accessory drive system. This system combines the alternator and starter motor into one device that can be mounted in effectively the same way and in effectively the same packaging space as a traditional alternator. The BAS system must be able to effect a restart of the engine quickly and quietly. The engine is cranked by the combined alternator/starter motor unit whose driven pulley is linked with the engine's output shaft mounted drive pulley by a flexible drive belt. This flexible drive belt has a tension or taut side and slack side while the engine is running. A flexible drive belt tensioner is typically employed to maintain tension on the slack side of the flexible drive belt. Without this tension, the flexible drive belt may slip, which in turn may cause “belt squeal” or, in extreme cases, belt damage and loss of accessory function. A typical flexible drive belt tensioner consists of an idler pulley which is in communication with the flexible drive belt, a spring to provide the necessary force to the idler pulley, and a viscous damper operable to dampen any resonances that may be induced in the tensioner by the flexible drive belt.

When a request is made to restart the engine, the driven pulley mounted to the combined alternator/starter motor will impart the rotational force necessary to crank the engine to the output shaft mounted via the flexible drive belt. Consequently, the normally slack side of the flexible drive belt becomes the tension side during engine restart. To maintain the required frictional force between the flexible drive belt and the drive and driven pulleys during restart, a flexible drive belt tensioner with a very high spring load is often employed. This spring load is much higher than would be necessary to maintain slack side tension for a non-BAS system or the BAS system while the engine is in running mode.

U.S. Pat. No. 4,758,208, to Bartos et al., issued Jul. 19, 1988 to the assignee of the present invention, and hereby incorporated by reference in its entirety, describes a mechanical belt tensioner assembly that uses the shifting reaction torque incident to the change from generating to cranking mode and back to mechanically select one of a pair of tensioner arms to tension the slack side of a the flexible drive belt of a BAS accessory drive system.

### SUMMARY OF THE INVENTION

In view of the foregoing, the present invention provides an improved automotive accessory drive system incorporating a selectively lockable flexible drive belt tensioner, which is especially useful with engines employing the BAS system. In addition, the present invention also provides a method of restarting a BAS system equipped engine.

The present invention utilizes a variable viscosity fluid within the damper element of the flexible drive belt tensioner and operable to lock the flexible drive belt tensioner in place when energized. This variable viscosity fluid may be magneto-rheological or electro-rheological in nature. The magneto-rheological fluid will exhibit a substantial increase in viscosity, or resistance to flow, in the presence of a magnetic field. This magnetic field is often a coil generated electromagnetic field. Alternately, the electro-rheological fluid is energized by the presence of an electrical field with in the fluid. This field is created in the electro-rheological fluid by electrodes mounted within the electro-rheological fluid. The viscosity of both the magneto-rheological and electro-rheological fluids will increase to a point of near solidification when energized.

When a start request is made by the operator of the BAS system equipped vehicle, usually by turning the ignition key or lifting the brake pedal, a control unit will command the flexible drive belt tensioner to lock in position. This selectively lockable characteristic may be achieved by either providing the damper element with a magnetic field if the damper is filled with magneto-rheological fluid, or an electric field in the case of an electro-rheological fluid. The viscosity of the fluid will increase to such a degree that the damper element of the tensioner will become locked. The control unit will subsequently command the combined alternator/starter motor to crank the engine. Upon engine restart, the control unit will de-energize the variable viscosity fluid, thereby unlocking the flexible drive belt tensioner. Both magneto-rheological and electro-rheological fluids retain excellent damping characteristics when de-energized, therefore, the normal operation of the flexible drive belt tensioner will not be affected. The ability to selectively lock and unlock the flexible drive belt tensioner will obviate the need for an overly aggressive spring load for the flexible drive belt tensioner. Therefore, the flexible drive belt life and bearing life of the accessory drive components may increase with the use of the present invention.

Accordingly, the present invention provides an automotive accessory drive system having a drive pulley connected to an engine output shaft and a plurality of driven pulleys, each of which is connected to one of a plurality of driven devices. Also provided is a flexible drive belt connectively coupling the drive pulley and the plurality of driven pulleys and operable to transfer drive forces between the drive pulley and the plurality of driven pulleys. Also provided is a selectively lockable flexible drive belt tensioner operable to maintain frictional engagement between the flexible drive belt and the drive pulley and at least one of the plurality of driven pulleys, the flexible drive belt tensioner including a damper element having a variable viscosity fluid disposed therein. The variable viscosity fluid being operable to lock the flexible drive belt tensioner when the variable viscosity fluid is energized and unlock the flexible drive belt tensioner when the variable viscosity fluid is de-energized. A control unit operable to selectively energize and de-energize the variable viscosity fluid disposed within the damper element of the flexible drive belt tensioner is also provided.

The automotive accessory drive system of the present invention may have one of the plurality of driven pulleys connected to a combined alternator/starter motor.

The automotive accessory drive system of the present invention may have a damper element filled with a variable viscosity fluid such as a magneto-rheological fluid energizable by a magnetic field created within the magneto-rheological fluid by a conductive coil mounted with respect to the damper element.

Alternately, the automotive accessory drive system of the present invention may have a damper element filled with a variable viscosity fluid such as an electro-rheological fluid energizable by an electric field created within the electro-rheological fluid by a plurality of electrodes mounted within the damper element and in communication with the electro-rheological fluid.

The present invention also provides a method of restarting an automotive engine having a Belt Alternator Starter system with a flexible drive belt tensioner. The flexible drive belt tensioner includes a variable viscosity fluid filled damper element. The variable viscosity fluid is sufficiently energized when restarting the automotive engine to maintain a desired belt tension for restarting. The flexible drive belt tensioner is unlocked subsequent to engine restart by de-energizing the variable viscosity fluid within the damper element. The variable viscosity fluid may be either magneto-rheological or electro-rheological in nature.

The present invention also provides an automotive accessory drive system for a plurality of driven devices having a drive pulley connected to an engine output shaft and a plurality of driven pulleys, each of which is connected to one of a plurality of driven devices, one of which is a combined alternator/starter motor. A flexible drive belt connectively couples the drive pulley and the plurality of driven pulleys and is operable to transfer drive forces between the drive pulley and the plurality of driven pulleys. Also provided is a flexible drive belt tensioner that is selectively lockable to maintain frictional engagement between the flexible drive belt and the drive pulley and at least one of the plurality of driven pulleys, wherein the flexible drive belt tensioner includes a damper element having a variable viscosity fluid disposed therein. The variable viscosity fluid is energizable to selectively lock the flexible drive belt tensioner when the variable viscosity fluid is energized.

The automotive accessory drive system for a plurality of driven devices of the present invention may have a variable viscosity fluid that is magneto-rheological in nature disposed within the damper element. The system may further have a control unit operable to command a conductive coil mounted with respect to the damper element to energize the magneto-rheological fluid disposed within the damper element of the flexible drive belt tensioner and subsequently command the conductive coil to de-energize the magneto-rheological fluid.

The automotive accessory drive system for a plurality of driven devices of the present invention may have a variable viscosity fluid that is electro-rheological in nature disposed within the damper element. The system may further have a control unit operable to command a plurality of electrodes mounted within the variable viscosity fluid to energize the electro-rheological fluid disposed within the damper element of the flexible drive belt tensioner and subsequently command the plurality of electrodes to de-energize the electro-rheological fluid.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 illustrates a front view of a BAS automotive accessory drive system consistent with the present invention;

FIG. 2a illustrates a fragmentary sectional view of one embodiment of a flexible drive belt tensioner damper element filled with a magneto-rheological fluid in accordance with the present invention; and

FIG. 2b illustrates a fragmentary sectional view of another embodiment of a flexible drive belt tensioner damper element filled with an electro-rheological fluid in accordance with the present invention.

### DESCRIPTION OF THE PREFERRED EMBODIMENTS

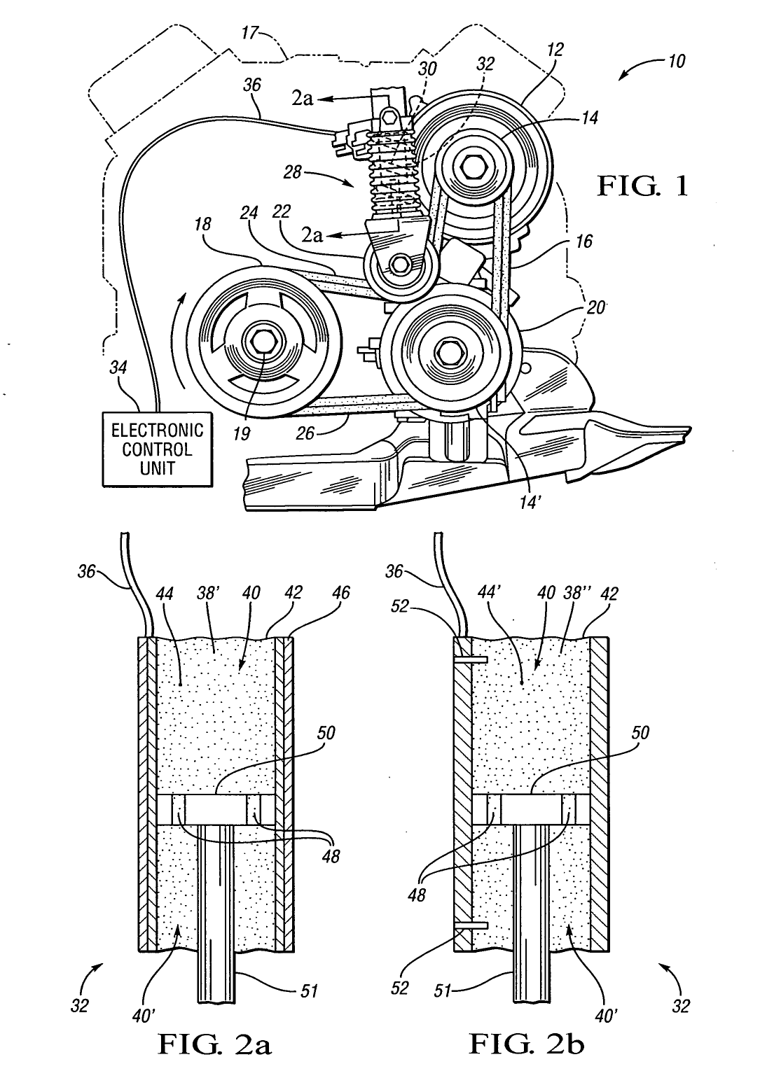

FIG. 1 illustrates a Belt Alternator Starter (BAS) accessory drive system 10 consistent with the present invention. The BAS accessory drive system 10 has, as its main component, a combined alternator/starter motor 12 operable to effect a restart of the engine 17 as well as to provide a charging circuit for the electrical system of the vehicle. A driven pulley 14 is connectively configured to the combined alternator/starter motor 12, and is in frictional engagement with a flexible drive belt 16. The flexible drive belt 16 transmits drive forces between the driven pulley 14 and the drive pulley 18. The drive pulley 18 is connectively configured to the engine's output shaft 19. The typical BAS accessory drive system 10 may also include other driven pulley mounted accessories known in the art such as, a power steering pump, water pump, secondary air pump, or as in FIG. 1, an air conditioning compressor 20. In addition, the BAS accessory drive system 10 may also include one or more idler pulleys such as 22. An idler pulley 22 may be used to ensure proper flexible drive belt 16 “wrap” around a given driven pulley 14 or drive pulley 18, or may be used to ensure proper flexible drive belt 16 routing.

Due to the rotational nature of the drive pulley 18 to that of the driven pulleys 14 and 14′, the flexible drive belt 16 will have a slack side 24 and a tension or taut side 26 on either side of the drive pulley 18 during normal engine running conditions. The presence of a slack side 24 necessitates the use of a flexible drive belt tensioner 28. The flexible drive belt tensioner 28 is operable to maintain frictional engagement between the flexible drive belt 16 and the driven pulley 14. In the absence of a flexible drive belt tensioner 28, the BAS accessory drive system 10 would be prone to flexible drive belt 16 slippage, which could possibly emit an unpleasant noise referred to as “belt squeal”. In extreme cases, this slippage may lead to flexible drive belt 16 damage and loss of accessory function.

A flexible drive belt tensioner 28 typically consists of an idler pulley 22 for flexible drive belt 16 engagement, a spring element 30 operable to provide the necessary tension in the flexible drive belt 16, and a damper element 32 capable of attenuating any vibrations introduced by the flexible drive belt 16. The prior art BAS equipped accessory drive system will typically employ a spring with a very high spring rate. This spring rate is necessary to counteract the reversal of the slack side 24 and tension or taut side 26 of the flexible drive belt 16 during engine restart by the combined alternator/starter motor 12. The selectively lockable nature of the flexible drive belt tensioner 28 of the present invention will obviate the need for a spring 30 with a high spring rate by selectively locking the flexible drive belt tensioner 28 in place during critical points of the engine restart procedure.

The flexible drive belt tensioner 28 of the present invention includes a damper element 32 in electrical connectivity with the control unit 34 though the electrical connection 36. FIG. 2a is a sectional illustration of a first exemplary embodiment of a damper element 32 for a selectively lockable flexible drive belt tensioner 28. The damper element 32 contains a variable viscosity fluid 38 disposed within two variable volume cavities 40 and 40′ defined by the inside diameter of cylinder 42 and piston 50 which is reciprocally movable within cylinder 42. In the preferred embodiment, the variable viscosity fluid 38 will be a magneto-rheological fluid 38′. The magneto-rheological fluid 38′ has a dense suspension of micrometer-sized particles 44 in a liquid that will cause the magneto-rheological fluid 38′ to solidify into a pasty consistency of high viscosity in the presence of a magnetic field, and re-liquefy upon removal of the field. In this example, the cylinder 42 of the damper element 32 has a conductive coil 46 wrapped around the outer diameter of cylinder 42 and in electrical communication with the electronic control unit 34 by electrical connection 36. By supplying current to the conductive coil 46, an electromagnetic field is created within the magneto-rheological fluid 38′. This field will cause the viscosity of the magneto-rheological fluid 38′ to increase to a point where flow through the passages 48 defined by piston 50, which is reciprocally movable within the cylinder 42, is no longer possible. At which point, the two variable volume cavities 40 and 40′ will remain at fixed volumes, thereby restricting the movement of piston 50 and effectively locking the flexible drive belt tensioner 28. The rod 51 couples the idler pulley 22 to the piston 50 and provides the reactive force necessary to maintain the idler pulley 22 in a fixed translational position against the flexible drive belt 16. When the conductive coil 46 is de-energized, the magneto-rheological fluid 38′ will return to its former viscosity, and the normal operation of the flexible drive belt tensioner 28 will be unaffected.

FIG. 2b is a sectional illustration of a second exemplary embodiment of a damper element 32 operable to selectively lock the flexible drive belt tensioner 28. In lieu of filling the two variable volume cavities 40 and 40′ with a magneto-rheological fluid 38′, an electro-rheological fluid 38″ is employed. Electro-rheological fluids 38″ operate like magneto-rheological fluids 38′, with the exception that their viscosity increases in the presence of an electrical field. In this embodiment, the electronic control unit 34 through the electrical connection 36, selectively energizes electrodes 52. The electrodes 52 are mounted within the electro-rheological fluid 38″. Upon application of an electrical current to the electrodes 52, the viscosity of the electro-rheological fluid 38″ will increase to a point where flow through the passages 48 defined by piston 50, which is reciprocally movable within the cylinder 42, is no longer possible. At which point, the two variable volume cavities 40 and 40′ will remain at fixed volumes, restricting the movement of piston 50 and effectively locking the flexible drive belt tensioner 28. The rod 51 couples the idler pulley 22 to the piston 50 and provides the reactive force necessary to maintain the idler pulley 22 in a fixed translational position against the flexible drive belt 16. When the electrodes 52 are de-energized, the electro-rheological fluid 38″ will return to its former viscosity, and the normal operation of the flexible drive belt tensioner 28 will be unaffected.

The flexible drive belt tensioner 28 as illustrated is direct acting, meaning that the idler pulley 22 will travel in a purely linear path. It is not the inventors' intention to limit the scope of this invention to only direct acting tensioners. The idler pulley 22 may be made to travel in an arc with the addition of a bell crank mechanism while still falling within the scope of the invention. In addition, the internal configuration of the damper element 32 may be of other designs than those cylindrical designs presented, such as rotary-type dampers, while still falling within the spirit of that which is claimed.

The selectively lockable nature of the flexible drive belt tensioner 28 is of particular benefit when employed in a BAS accessory drive system 10. When a start request is made by the operator of the BAS accessory drive system 10 equipped vehicle, usually by turning the ignition key or lifting the brake pedal, an electronic control unit 36 will command the damper element 32 of the flexible drive belt tensioner 28 to lock in position by energizing the variable viscosity fluid 38 therewithin. The electronic control unit 34 will subsequently command the combined alternator/starter motor 12 to crank the engine. The locked flexible drive belt tensioner 28 will provide the tension to the flexible drive belt 16 necessary to maintain frictional engagement of the driven pulley 14 and the drive pulley 18. Upon engine restart, the electronic control unit 34 will de-energize the variable viscosity fluid 38, thereby unlocking the flexible drive belt tensioner 28. The ability to selectively lock and unlock the flexible drive belt tensioner 28 will obviate the need for an overly aggressive spring load for the flexible drive belt tensioner 28. Therefore, the life of the flexible drive belt 16 and bearing life of the accessory drive components may increase

While the best modes for carrying out the invention have been described in detail, those familiar with the art to which this invention relates will recognize various alternative designs and embodiments for practicing the invention within the scope of the appended claims.

1. An automotive accessory drive system comprising:
a drive pulley connected to an engine output shaft;
a plurality of driven pulleys each of which is connected to one of a plurality of driven devices;
a flexible drive belt connectively coupling said drive pulley and said plurality of driven pulleys and operable to transfer drive forces between said drive pulley and said plurality of driven pulleys;
a selectively lockable flexible drive belt tensioner operable to maintain frictional engagement between said flexible drive belt and said drive pulley and at least one of said plurality of driven pulleys, said flexible drive belt tensioner including a damper element having a variable viscosity fluid disposed therein, said variable viscosity fluid being operable to lock said flexible drive belt tensioner when said variable viscosity fluid is energized, and unlock said flexible drive belt tensioner when said variable viscosity fluid is de-energized; and
a control unit operable to selectively energize and de-energize said variable viscosity fluid disposed within said damper element of said flexible drive belt tensioner.

2. The automotive accessory drive system of claim 1, wherein one of said plurality of driven pulleys is connected to a combined alternator/starter motor.

3. The automotive accessory drive system of claim 1, wherein said variable viscosity fluid is a magneto-rheological fluid energizable by a magnetic field created within said magneto-rheological fluid by a conductive coil, said conductive coil being mounted with respect to said damper element.

4. The automotive accessory drive system of claim 1, wherein said variable viscosity fluid is an electro-rheological fluid energizable by an electric current created within said electro-rheological fluid by a plurality of electrodes, said plurality of electrodes being mounted within said damper element and in communication with said electro-rheological fluid.

5. A method of restarting an automotive engine having a Belt Alternator Starter (BAS) system with a flexible drive belt tensioner:
providing said flexible drive belt tensioner with a variable viscosity fluid filled damper element;
sufficiently energizing said variable viscosity fluid within said damper element when restarting said automotive engine to maintain a desired belt tension for restarting; and
unlocking said flexible drive belt tensioner subsequent to engine restart by de-energizing said variable viscosity fluid within said damper element upon engine restart.

6. The method of restarting an automotive engine having a Belt Alternator Starter (BAS) system with a belt tensioner of claim 5, wherein said variable viscosity fluid is a magneto-rheological fluid.

7. The method of restarting an automotive engine having a Belt Alternator Starter (BAS) system with a belt tensioner of claim 5, wherein said variable viscosity fluid is an electro-rheological fluid.

8. An automotive accessory drive system for a plurality of driven devices comprising:
a drive pulley connected to an engine output shaft;
a plurality of driven pulleys each of which is connected to one of said plurality of driven devices, one of said plurality of driven devices being a combined alternator/starter motor;
a flexible drive belt connectively coupling said drive pulley and said plurality of driven pulleys and operable to transfer drive forces between said drive pulley and said plurality of driven pulleys; and
a flexible drive belt tensioner selectively lockable to maintain frictional engagement between said flexible drive belt and said drive pulley and at least one of said plurality of driven pulleys, wherein said flexible drive belt tensioner includes a damper element having a variable viscosity fluid disposed therein, which is energizable to selectively lock said flexible drive belt tensioner when said variable viscosity fluid is energized.

9. The automotive accessory drive system for a plurality of driven devices of claim 8, wherein the variable viscosity fluid is a magneto-rheological fluid, and further having a control unit operable to command a conductive coil mounted with respect to said damper element to energize said magneto-rheological fluid disposed within said damper element of said flexible drive belt tensioner and subsequently command said conductive coil to de-energize said magneto-rheological fluid.

10. The automotive accessory drive system for a plurality of driven devices of claim 8, wherein the variable viscosity fluid is an electro-rheological fluid, and further having a control unit operable to command a plurality of electrodes mounted within said variable viscosity fluid to energize said electro-rheological fluid disposed within said damper element of said flexible drive belt tensioner and subsequently command said plurality of electrodes to de-energize said electro-rheological fluid
